(19) United States
(12) Patent Application Publication
(10) Pub. No.: US 2009/0160729 A1
(43) Pub. Date: Jun. 25, 2009

(54) ANTENNA ARRAY WITH REDUCED ELECTROMAGNETIC COUPLING

(75) Inventors: Warren F. Hunt, Farmington, CT (US); Patrick Le Cam, Lannion (FR); Marco Kunze, Hamburg (DE); Jean-Pierre Harel, Lannion (FR); Nicolas Cojean, Lannion (FR); Sunny Sun, Shanghai (CN)

Correspondence Address: FAY SHARPE/LUCENT, 1228 Euclid Avenue, 5th Floor, The Halle Building, Cleveland, OH, 44115-1843, US

(73) Assignee: Alcatel-Lucent

(21) Appl. No.: 12/337,138

(22) Filed: Dec. 17, 2008

(30) Foreign Application Priority Data
Dec. 18, 2007 (FR) 0759921

(51) Int. Cl. H01Q 21/00

(52) U.S. Cl. 343/893

(57) ABSTRACT

The object of the present invention is an antenna system comprising at least one first antenna and at least one second antenna, each comprising spaced-apart radiating elements aligned along the longitudinal axis of the antenna, the second antenna being disposed a short distance away from, and parallel to, the first antenna, characterized in that the plane perpendicular to the longitudinal axis passing through a radiating element of the first antenna is displaced in the direction of the longitudinal axis with respect to the plane perpendicular to the longitudinal axis passing through the radiating element of the second antenna which is closest to it.

### CROSS-REFERENCE TO RELATED APPLICATIONS

This application is based on French Patent Application No 07 59 921 filed on Dec. 18, 2007, the disclosure of which is hereby incorporated by reference thereto in its entirety, and the priority of which is hereby claimed under 35 U.S.C. §119.

### BACKGROUND OF THE INVENTION

The present invention pertains to a system of panel radio frequency antennas used for telecommunication services, telemetry, tracking, radar, etc.

A telecommunications antenna, for example one such as those installed in the base station of a mobile telephony network, sends and receives radio waves along frequencies that belong to a telecommunication system operated by that antenna. To do so, a base station feeds each antenna with waves having frequencies within a band used by that antenna. Thus, certain antennas intended for the GSM (Global System for Mobile Communications) system use waves whose frequencies are within the 870-960 MHz band, and other antennas intended for the UMTS (Universal Mobile Telecommunications System) system use waves whose frequencies are within the 1710-2170 MHz band.

Therefore, numerous applications involve placing two or more panel antennas side-by-side. However, this configuration requires the resulting electromagnetic coupling between the radiating elements of the neighboring antennas to be minimized. Electromagnetic coupling between antennas has harmful consequences, not only on the level of electromagnetic energy coming from the antenna, which may be received by one or more of the neighboring antennas (known as “decoupling” between antennas), but also on other effects related to the antenna's radiation spectrum, such as deviations from the stability of spectral performance.

Currently, in order to associate one or more antennas placed side-by-side, for example within a shared radome, an effort is made to select antennas having similar constraints, and disposing them symmetrically with respect to the radome's axis.

However, this solution makes the installation of such a system more complex and expensive.

Alternatively, in order to reduce coupling between radiating elements, manufacturers have also considered increasing the physical lateral distance separating the arrays of elements. For example, the document US-2002/180,439 describes a magnetic resonance imaging (MRI) installation comprising a detection device having parallel conductors each nλ/4, in length, where λ is the wavelength of the signal, and n is an integer greater than or equal to one. It is provided that the s/h ratio between the distance s separating two radiating elements and the height h of the antenna-covering part, is such that s/h≧2.5.

However, although this solution has proven effective at reducing coupling, the lateral distance between the radiating elements has the disadvantage of significantly increasing the total volume of the antenna system.

Another solution considered for reducing unwanted electromagnetic coupling is adding additional dielectric or conductive parts (made of metal), disposed between the antennas or inside the antenna. In practice, this sort of solution is functionally effective; however, it requires a long design and simulation test phase, in order to reduce the coupling of the antennas without degrading the prior performance of each antenna.

### SUMMARY OF THE INVENTION

The purpose of the present invention is to eliminate the drawbacks of the prior art, and, in particular, to disclose an alternative solution for reducing coupling between the radiating elements of neighboring antennas, which limits the increase in the total volume of the entire antenna system.

The object of the present invention is an antenna system comprising at least one first antenna comprising an array of spaced-apart radiating elements aligned along the longitudinal axis of the antenna, and at least one second antenna comprising an array of spaced-apart radiating elements aligned along the longitudinal axis of the antenna, the second antenna being disposed a short distance away from, and parallel to, the first antenna.

According to the invention, the second antenna is longitudinally separated from the first antenna in such a way that the plane perpendicular to the longitudinal axis passing through a radiating element of the first antenna is located between two radiating elements of the second antenna.

The plane perpendicular to the longitudinal axis passing through a radiating element of the first antenna is thereby displaced in the direction of the longitudinal axis with respect to the plane perpendicular to the longitudinal axis passing through the radiating element of the second antenna which is closest to it.

Preferentially, the longitudinal distance between the first antenna and the second antenna is such that the direction of maximum radiation of a radiating element of the first antenna is located between two radiating elements of the second antenna.

According to one particular embodiment of the invention, the longitudinal distance between the first antenna and the second antenna is equal to half the distance separating the radiating elements.

The use of the invention is not dependent upon the physical size of the antenna system, its frequency band, its polarization, or its multipolarization.

The antennas placed side-by-side in this manner only increase the total length of the system very slightly, and the mechanical performance of the system overall remains unchanged, particularly with respect to its wind speed resistance rate.

Thanks to the invention, the methodology for reducing coupling between antennas is simplified, and the impact on the antenna's characteristics and its size is greatly reduced.

The invention is suitable for any application that includes the use of two or more panel antennas placed side-by-side, such as telecommunication services, telemetry, mobile-tracking, radars, etc.

### BRIEF DESCRIPTION OF THE DRAWINGS

Other characteristics and advantages of the present invention will become apparent upon reading the following description of an embodiment, which naturally is given by way of a non-limiting example, and in the attached drawing, in which

FIG. 1 schematically depicts a top view of the respective position of two panel antennas of a system found in the prior art, wherein significant electromagnetic coupling occurs between the radiating elements,

FIG. 2 is a schematic perspective view of a radiating element,

FIG. 3 schematically depicts a top view of the respective position of two panel antennas in accordance with one embodiment of the invention, wherein the electromagnetic coupling between the elements is reduced,

FIG. 4 is analogous to FIG. 2, for a system comprising a plurality of antennas,

FIG. 5 is a perspective view of an antenna according to one particular embodiment of the invention.

### DETAILED DESCRIPTION OF THE PREFERRED EMBODIMENTS

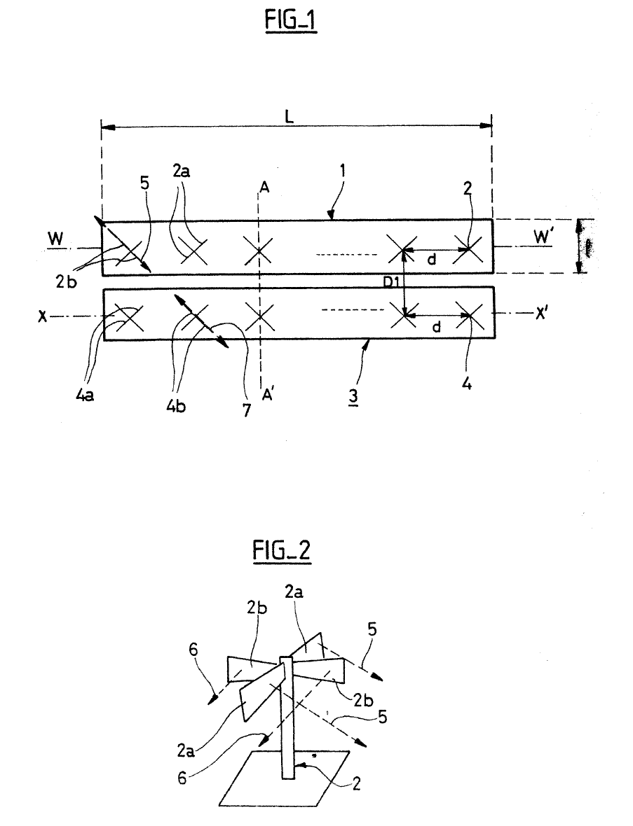

FIG. 1 shows a first antenna 1 comprising an array of radiating elements 2 aligned an equal distance apart from one another along the W-W′ axis of the antenna 1. The first panel antenna 1 is of a length L much greater than its width w. A second panel antenna 3 analogous to the antenna 1 comprises an array of radiating elements 4 aligned at an equal distance from one another along the X-X′ axis of the antenna 3. In accordance with the prior art, the second antenna 3 is placed beside the first antenna 1 parallel to it and a short distance away from it, in such a way that two neighboring radiating elements 2 and 4 are located within a single plane A-A′ perpendicular to the X-X′ and W-W′ axes, and are separated by a distance D1.

The radiating elements 2, 4 are dual-polarized, meaning that they are made of two concentric perpendicular dipoles 2a, 2b and 4a, 4b: a +45°-polarization dipole 2a, 4a and a −45°-polarization dipole 2b, 4b which are insulated from one another, from a radio frequency standpoint.

As is shown in greater detail in FIG. 2, for a given radiating element 2 the +45°-polarization dipole 2a radiates with maximum intensity in the direction 5 perpendicular to its longitudinal axis, and the −45°-polarization dipole 2b radiates with maximum intensity in the direction 6 perpendicular to its longitudinal axis.

Likewise, for a given radiating element 4, the +45°-polarization dipole 4a radiates with maximum intensity in the direction 7 perpendicular to its longitudinal axis. In the arrangement shown in FIG. 1, it may be seen that the two directions 5 and 7 overlap. It is therefore understood that electromagnetic coupling inevitably occurs between the radiating elements 2 and 4.

By increasing the distance D1 in order to reduce this coupling, the size of the system is increased. Based on theoretical calculations, it has been observed that it is necessary to double the distance between the respective axes of the two antennas to achieve a 3 dB reduction in coupling. For example, for two antennas whose axes are initially separated by 170 mm, the 3 dB reduction in coupling would require increasing that distance to 340 mm, i.e. the dual antenna system's total width would increase from 340 mm to 510 mm, which represents a 50% increase in width.

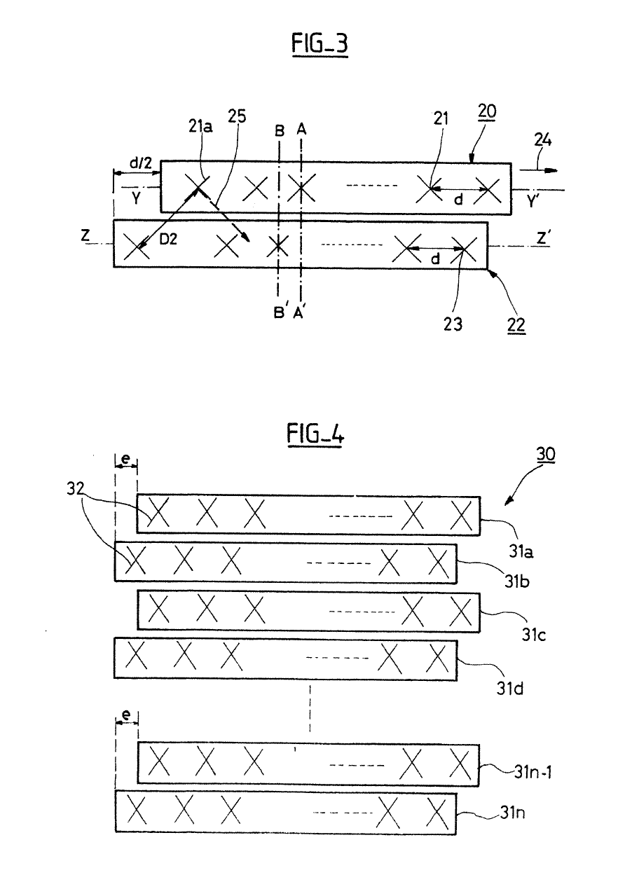

In accordance with one embodiment of the inventive antenna system, FIG. 3 shows a first antenna 20 comprising radiating elements 21 aligned at an equal distance from one another along the Y-Y′ axis of the antenna 20, and a second antenna 22 comprising radiating elements 23 aligned at an equal distance from one another along the Z-Z′ axis of the antenna 22. The second antenna 22 is placed beside the first antenna 20, parallel to it and a short distance away from it. The first antenna 20 is in a relative position which, with respect to the second antenna 22, is shifted away from it in the direction of the arrow 24 along the Y-Y′ longitudinal axis of a length d/2, i.e. half the distance d that separated two adjacent radiating elements 21. The plane A-A′ perpendicular to the Y-Y′ axis and passing through a radiating element 21 is thereby displaced by a length d/2 in the direction of the arrow 24 with respect to the plane B-B′ perpendicular to the axis Z-Z′ and passing through a radiating element 23. As a result, a radiating element 21 of the first antenna 20 is separated from the element 23 of the antenna 22 which is closest to it by a distance D2.

The distance between the two antennas 20, 23 is such that the maximum radiation of the dipole 21a, for example, of the radiating elements 21 of the first antenna 20, occurs in a direction 25 which passes between the radiating elements 23 of the second antenna 23. In this arrangement, minimal coupling is achieved between the elements 21 and 23, while the total size of the dual antenna system was increased by a minimal volume. By way of example, let us consider the case of a dual antenna system wherein each antenna, comprising ten elements, has a length of 10d. A displacement by a distance d/2 in the direction of the longitudinal axis of the plane perpendicular to the longitudinal axis passing through a radiating element of the first antenna with respect to the plane perpendicular to the longitudinal axis passing through the radiating element of the second antenna which is closest to it, leads to an increase in the system's surface area of just 5%.

This embodiment pertains to panel antennas comprising several identical radiating elements disposed in a repetitive manner at an equal distance from one another. These elements will be the maximum distance apart from one another if the displacement corresponds to half the distance between elements, d/2.

In the event that the radiating elements of a first antenna are separated by a distance H1, and those of a second antenna are separated by H2, the best compromise for the distance of the displacement may be equal to (H1+H2)/4. This particularly pertains to frequency ranges found within the same range, such as those of DCS and UMTS systems.

However, for dual-polarized antennas, the energy received by each radiating element is the sum of the energy originating from the other radiating elements with the same polarization plus the energy originating from the radiating elements with the other polarization. Depending on the situation, and assuming that the energy coupling between the radiating elements with the same polarization is different from the energy coupling between radiating elements with a different polarization, the most appropriate distance to reduce the resulting coupling may be different from the half-distance between the elements in the simplified scenario described above.

In practice, the optimal distance must be determined for each antenna system's specific situation, taking into account differences in the phase and amplitude of the feeds of their radiating elements.

The invention also applies to systems comprising multiple antennas. The system 30 depicted in FIG. 3 comprises antennas 31a-31n, with the contiguous antennas being respectively set apart from one another by a distance e in the longitudinal direction in such a way that the radiating elements 32 of two adjacent antennas 31a, 31b are not located within the same plane perpendicular to the direction of the axis of the antennas 31a, 31b.

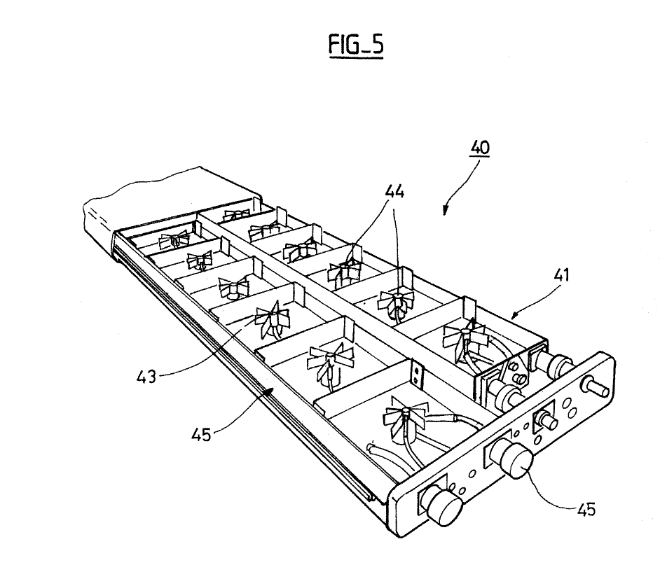

FIG. 4 depicts a perspective view of an embodiment of an antenna system 40 according to the present invention, comprising a first antenna 41 and a second antenna 42. Each antenna 41, 42 respectively comprises an array of analogous radiating elements 43, 44 fed by way of connectors 45. The radiating elements 43 of the first antenna 41 are displaced in the longitudinal direction by a distance such that each element 43 is at an equal distance from the closest radiating elements 44 of the other antenna 42.

1. An antenna system comprising at least one first antenna comprising an array of spaced-apart radiating elements aligned along the longitudinal axis of the antenna, and at least one second antenna comprising an array of spaced-apart radiating elements aligned along the longitudinal axis of the antenna, the second antenna being disposed a short distance away from, and parallel to, the first antenna, wherein the second antenna is longitudinally displaced away from the first antenna in such a way that the plane perpendicular to the longitudinal axis passing through a radiating element of the first antenna is located between two radiating elements of the second antenna.

2. A system according to claim 1, wherein the longitudinal distance between the first antenna and the second antenna is such that the direction of maximum radiation of a radiating element of the first antenna is located between two radiating elements of the second antenna.

3. A system according to claim 1, wherein the longitudinal distance between the first antenna and the second antenna is equal to half the distance separating the radiating elements.
